(19) United States
(12) Patent Application Publication
(10) Pub. No.: US 2008/0269068 A1
(43) Pub. Date: Oct. 30, 2008

(54) MULTIPLEX DECODING OF SEQUENCE TAGS IN BARCODES

(75) Inventors: George M. CHURCH, Brookline, MA (US); Jay Shendure, Chagrin Falls, OH (US); Gregory J. Porreca, Ocean City, NJ (US); Nikos Reppas, Cedar Falls, IA (US)

Correspondence Address: BANNER & WITCOFF, LTD., 28 STATE STREET, 28th FLOOR, BOSTON, MA, 02109-9601, US

(73) Assignee: President and Fellows of Harvard College, Cambridge, MA (US)

(21) Appl. No.: 12/027,039

(22) Filed: Feb. 6, 2008

Related U.S. Application Data
(60) Provisional application No. 60/888,374, filed on Feb. 6, 2007.

(51) Int. Cl. C40B 30/04; C40B 50/06

(52) U.S. Cl. 506/9; 506/26

(57) ABSTRACT

Methods and compositions for performing multiplex reactions are provided.

### RELATED APPLICATION

This application claims priority from U.S. provisional patent application No. 60/888,374, filed Feb. 6, 2007 which is hereby incorporated herein by reference in its entirety for all purposes.

This application was funded in part by National Institutes of Health Grant No. HG003170. The government has certain rights to the invention.

### BACKGROUND

Current sequencing by ligation “SBL” reactions on a polony bead array require iterative cycles of ligation reactions followed by four-color imaging to determine DNA sequence one base pair per cycle. Each cycle takes approximately two hours to complete, and is composed of the following steps: 1) hybridize anchor primer (30 minutes); 2) ligate fluorescently-labeled query nonamer pool (30 minutes); 3) image (2 passes, 45 minutes total); 4) chemically strip signal from array (15 minutes); and 5) repeat. This protocol results in an instrument time of 52 hours for a paired-end bacterial re-sequencing run and 24 hours for a serial analysis of gene expression (SAGE) or barcode tag-sequencing run.

The approach of performing enzymatic reactions in a flow cell has many drawbacks. Reactions are less efficient than if performed ‘in a tube,’ and reaction time is constrained by desired high instrument-throughput (i.e., to the extent it influences cost). For example, if a method was discovered that resulted in better signal but required a four hour ligation, it would be impractical to perform as part of the cycled approach described above. A flow cell must be capable of accurate, precise, rapid temperature control. This imposes significant limitations on design and introduces significant complexity. Regardless of the reaction time, it is best to minimize the amount of instrument ‘downtime’ by maximizing the fraction of time spent collecting data. Where biochemistry time is significant, this can only be done by increasing the number of flow cells on the instrument and pipelining the biochemistry. Enzymatic labeling reactions limit the choice of labels available for use since the labeled species must serve as substrates for the labeling enzyme. For example, it is unrealistic to expect a quantum dot-tagged nonanucleotide to serve as a substrate for DNA ligase.

### SUMMARY

The present invention is based in part on the discovery of novel methods that allow the enzymatic portion of a sequencing protocol to be performed in a single multiplex reaction ‘offline’, e.g., in a vessel, before the start of the instrument run. Once in the instrument, room temperature hybridizations and rapid, efficient chemical stripping of hybridized ‘barcode query probes’ can be completed in approximately ten minutes. This eliminates the need for temperature control on the instrument, and brings the cycle time down to one hour per base for 5×10⁷ beads (1500 frames). Furthermore, since hybridization reactions are more stable than ligation reactions once mixed, and less variable from cycle to cycle, an entire run's worth of reagents can be prepared at the start of the run, and the cycles can be performed continuously without any manual intervention.

The present invention is also based in part on the discovery that decoupling a labeled species from an enzymatic reaction (e.g., using a non-fluorescently labelled oligomer (e.g., nonamer)) and adding the label at a later point (e.g., adding a label (e.g., a fluorescent label) by hybridization) allows for kinetically improved SBL protocols. Ligation of an oligonucleotide lacking a fluorescent label is kinetically favorable, particularly when multiple species are present (e.g., using four-species nonamers to query a single position) and yields stronger, more homogeneous signal upon detection by separate hybridizations (as described further herein) than is obtained using oligonucleotides having a fluorescent label.

Methods of analyzing an array of nucleic acid sequences including providing a plurality of immobilized query oligonucleotide sequences, providing a plurality of molecular inversion probes, each molecular inversion probe having a tag sequence, a barcode sequence, and two guide sequences, hybridizing the molecular inversion probes with the immobilized oligonucleotide sequences, performing rolling circle amplification such that the barcode sequence of one molecular inversion probe is transferred to one immobilized query oligonucleotide sequence, arraying the immobilized query oligonucleotide sequences, and identifying barcodes present on an immobilized query oligonucleotide sequence are provided. In certain aspects, multiple barcodes are present on the immobilized query oligonucleotide sequence. In other aspects, one or more steps prior to arraying can be performed at room temperature. In still other aspects, identifying barcodes present is performed by sequencing by hybridization. In certain aspects, the plurality of immobilized query oligonucleotide sequences are generated by emulsion PCR. In other aspects, the plurality of immobilized query oligonucleotide sequences are immobilized on beads, and the beads can optionally be arranged on a solid support. In certain aspects, sequencing by hybridization includes an oligonucleotide comprising a detectable label such as, for example, a fluorescent label. In other aspects, the plurality of immobilized query oligonucleotide sequences is a paired tag library.

Methods of providing a bead having two populations of immobilized query oligonucleotide sequences including the steps of providing a plurality of query oligonucleotide sequences immobilized on a bead, providing a plurality of first oligonucleotide sequences and second oligonucleotide sequences, wherein the first oligonucleotide sequences are complementary to query oligonucleotide sequences, and wherein the second oligonucleotide sequences comprise a mismatch at their 3′ termini when compared to the query oligonucleotide sequences, hybridizing the first and second oligonucleotide sequences to the query oligonucleotide sequences, adding polymerase to extend the hybridized oligonucleotide sequences, adding an enzyme that cleaves a specific deoxynucleoside, hybridizing a protection oligonucleotide to single stranded query oligonucleotide sequences, and adding a single strand-specific exonuclease to generate a bead having two populations of immobilized query oligonucleotide sequences are also provided. In certain aspects, the enzyme that cleaves a specific deoxynucleoside cleaves deoxyuridine. In other aspects, the first and second oligonucleotide sequences contain one or more deoxyuridines at their 5′ termini. In yet other aspects, the single strand-specific exonuclease is Exonuclease I. In still other aspects, a plurality of beads are arranged on a solid support.

Methods of analyzing an array of nucleic acid sequences including the steps of providing a plurality of query oligonucleotide sequences immobilized on beads, hybridizing a plurality of first oligonucleotide sequences and second oligonucleotide sequences to the immobilized oligonucleotide sequences, wherein the first oligonucleotide sequences are complementary to query oligonucleotide sequences, and wherein the second oligonucleotide sequences comprise a mismatch at their 3′ termini when compared to the query oligonucleotide sequences, adding polymerase to extend the hybridized oligonucleotide sequences, adding an enzyme that cleaves a specific deoxynucleoside, hybridizing a protection oligonucleotide to single stranded query oligonucleotide sequences, adding a single strand-specific exonuclease to generate two populations of immobilized query oligonucleotide sequences, hybridizing a plurality of molecular inversion probes to the immobilized query oligonucleotide sequences, performing rolling circle amplification such that a barcode sequence of a molecular inversion probe is transferred to an immobilized query oligonucleotide sequence, arraying the immobilized query oligonucleotide sequences, and identifying barcodes present on an immobilized query oligonucleotide sequence are provided. In certain aspects, one or more steps prior to arraying can be performed at room temperature. In other aspects, the step of identifying barcodes present is performed by sequencing by hybridization using, for example, an oligonucleotide comprising a detectable label. In yet other aspects, the beads are arranged on a solid support.

Further features and advantages of certain embodiments of the present invention will become more fully apparent in the following description of the embodiments and drawings thereof, and from the claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. The foregoing and other features and advantages of the present invention will be more fully understood from the following detailed description of illustrative embodiments taken in conjunction with the accompanying drawings in which:

FIG. 1 schematically depicts a clonal bead having a template nucleic acid sequence covalently attached thereto.

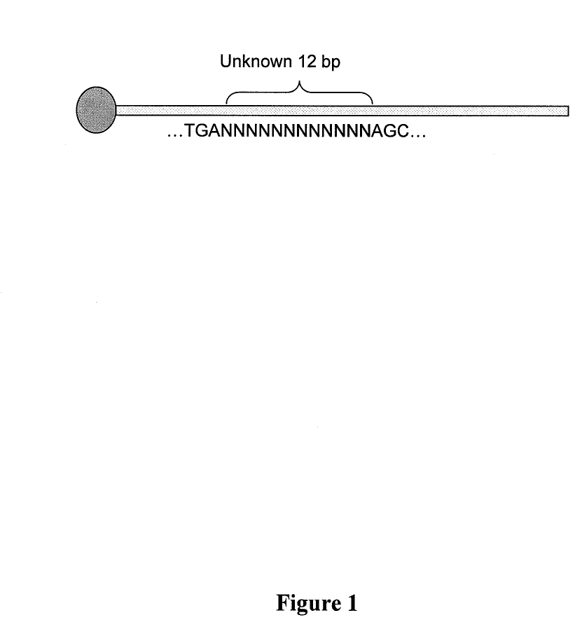

FIGS. 2A-2B schematically depict a molecular inversion probe hybridized to the clonal bead of FIG. 1. (A) depicts a hybridized molecular inversion probe prior to ligation. (B) depicts a hybridized molecular inversion probe after ligation.

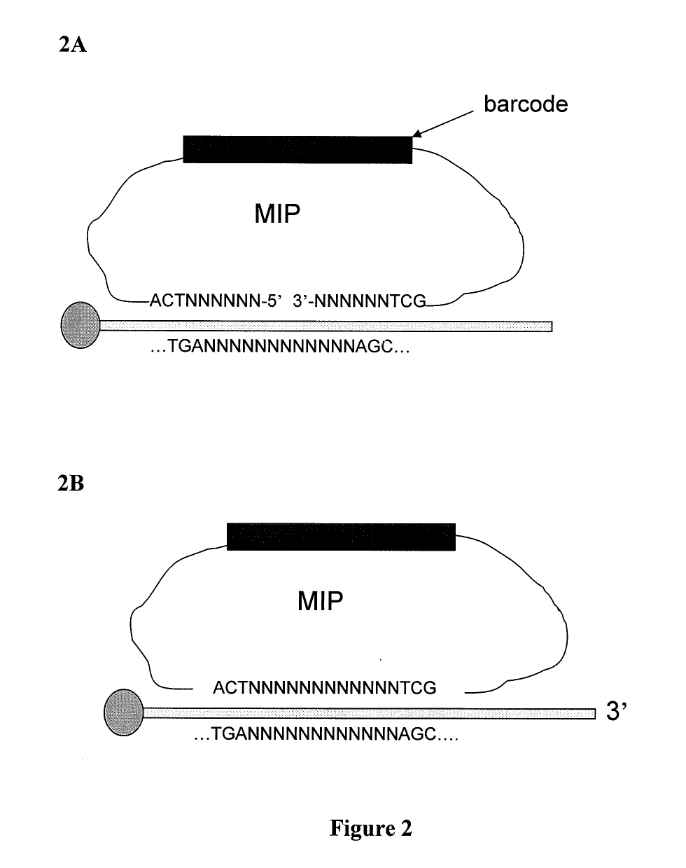

FIGS. 3A-3C schematically depict a molecular inversion probe hybridized to the clonal bead of FIG. 1. (A) depicts a hybridized molecular inversion probe after digestion with Exonuclease I to form a flush 3′ end on nucleic acid sequence covalently attached to the bead. (B) depicts rolling circle amplification (RCA).

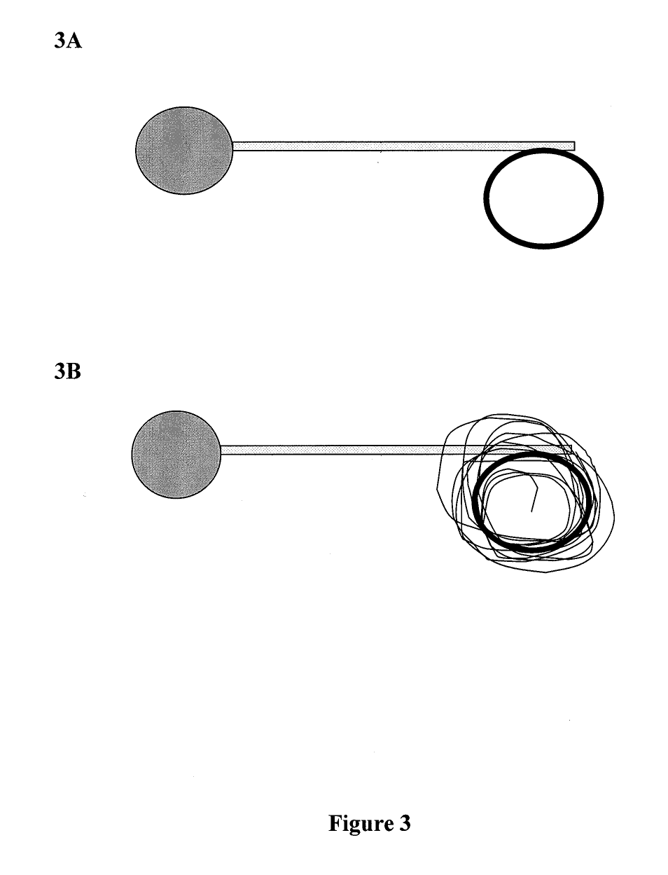

FIG. 4 schematically depicts sequencing by sequential hybridization of a bead on an array. At each cycle, sequences complementary to four barcodes, each bearing one of four fluorescent labels, are hybridized.

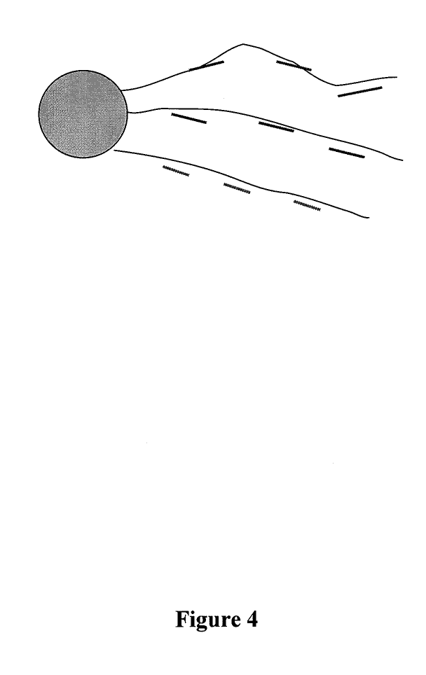

FIG. 5 schematically depicts a paired tag library with oligonucleotide binding sites shown. L15 and R15 are invariant 15-mer sequences that anchor the 5′ and 3′ ends of W (and similarly X, Y, and Z) to the end of A (and similarly B, C, and D); F is a fixed base; p+q=10 and 0≦p≦10 such that 10 different versions of W can be obtained with the central FₚCAGCAGF_{q} 16-mer sequence each as unique as possible and non-complementary to A/B/C/D; and CAGCAG is the EcoP15I restriction site (see right of step 1). Via EcoP15I digestion of W-primed amplicons, positions +1 to +10 of the tag1-5′ can be queried. Similarly, +1 to +10 of the tag1-3′, of tag2-5′, and of tag2-3′ can be queried by X-, Y-, and Z-primed amplicons, respectively. Step 1: 1st round emulsion PCR (ePCR) with single-molecule template, free primer b, and beads loaded with biotin-labeled versions of W, Y, X and Z. Bead-bound double-stranded amplicons W→b and Y→b will be generated. Step 2: The emulsion is broken and 2nd round e-PCR is performed with 1st rounds beads, no exogenous template and free primer a. Bead-bound double-stranded amplicons X→a and Z→a will be generated. One can ensure the W→b and Y→b amplicons are double-stranded by primer extension.

FIG. 6 schematically depicts forty types of primed-amplicons, each with a different EcoP151I 16-mer that specifies (1) the constant sequences A-D and (2) the query position of the associated tag sub-sequence. Step 1: EcoP51I digestion (in the presence of sinefungin (See Biochemical and Biophysical Research Communications (2005) 334:803). Each position to be queried (underlined) is associated with a specific EcoP15I 16-mer.

FIG. 7 schematically depicts forty types of digested amplicons, each with a different EcoP15I 16-mer and a two nucleotide 5′ overhang ready to be sequence-queried by hybridization-ligation. Step 1: 16 query adaptors are ligated with all possible two nucleotide 3′ overhangs, with 4 different 16-mer sequences associable with the identity of the 5′-most query base (magenta). 160 different pairings of 40 EcoP15I and 4 query 16-mers, separated by 17-26 bp, are possible on every bead. Step 2: non-biotinylated strands are denatured and washed away. The remaining structure is immobilized and loaded into a flow cell. No further enzyme-based steps are necessary from this point forward.

FIG. 8 schematically depicts an example hybridization in which forty four-color hybridization-imaging cycles to read four contiguous 10-mer tag sequences. At each cycle, the probe is a population of 32-mers with a constant 3′ 16-mer sequence complementary to one of the 40 EcoP15I 16-mers being interrogated, with 4 differentially fluor-labeled 5′ 16-mer sequences complementary to each of the 4 base-query 16-mers.

### DETAILED DESCRIPTION

The principles of the present invention may be applied with particular advantage in conjunction with molecular inversion probe (MIP)-mediated exon recovery methods (see, e.g., U.S. Ser. No. 60/846,256). As used herein, the term “MIP” refers to oligonucleotide sequences having one or more barcode sequences, one or more “guide sequences” that are complementary to specific position on a template target (such as a bead-bound oligonucleotide) and thus hybridize with this sequence, and one or more “tags” that are complementary to, and thus hybridize with, one or more query nucleic acid sequences that are targeted for sequencing. A MIP can form a circular structure (e.g., a “barcode circle”) when hybridized to a template target via hybridization of two or more guide sequences to the template target.

MIPs can be assembled in a variety of ways. For example, in certain embodiments, a tag is present at each of the 5′-most and the 3′-most ends of a MIP, a guide sequence is located just internal to each tag, and one or more barcode sequences are located in one or more remaining regions of the MIP. MIPs may optionally contain additional sequences in addition to guide sequences, tags and barcode sequences. In other embodiments, one or more tags are present at one end of the MIP (e.g., the 5′ end), one or more guide sequences are located at the other end of the MIP (e.g., the 3′ end), and one or more barcode sequences are located in one or more remaining regions of the MIP. In certain aspects, MIPs are at least 20, 30, 40, 50, 60, 70, 80, 90, 100, 110, 120, 130, 140, 150, 160, 170, 180, 190, 200 or more nucleotides in length. In certain exemplary embodiments, MIPs are approximately 100 nucleotides in length. Tags may range in size from 1 nucleotide in length to 20, 30, 40 or 50 or more nucleotides in length. In certain embodiments, tags are 1, 2, 3, 4, 5, 6, 7, 8, 9, 10, 11 or 12 nucleotides in length. Molecular inversion probes are described further in Hardenbol (1993) Nature Biotech. 21:6; Hardenbol et al. (2005) Genome Research 15:269; Fakhrai et al. (2003) Nature Biotech. 21(6):673; and Wang et al. (2005) Nucl. Acids Res. 33:e183.

As used herein, the term “barcode” refers to a unique oligonucleotide sequence that allows a corresponding nucleic acid base and/or nucleic acid sequence to be identified. In certain aspects, the nucleic acid base and/or nucleic acid sequence is located at a specific position on a larger polynucleotide sequence (e.g., a polynucleotide covalently attached to a bead). In certain embodiments, barcodes can each have a length within a range of from 4 to 36 nucleotides, or from 6 to 30 nucleotides, or from 8 to 20 nucleotides. In certain aspects, the melting temperatures of barcodes within a set are within 10° C. of one another, within 5° C. of one another, or within 2° C. of one another. In other aspects, barcodes are members of a minimally cross-hybridizing set. That is, the nucleotide sequence of each member of such a set is sufficiently different from that of every other member of the set that no member can form a stable duplex with the complement of any other member under stringent hybridization conditions. In one aspect, the nucleotide sequence of each member of a minimally cross-hybridizing set differs from those of every other member by at least two nucleotides. Barcode technologies are known in the art and are described in Winzeler et al. (1999) Science 285:901; Brenner (2000) Genome Biol. 1:1 Kumar et al. (2001) Nature Rev. 2:302; Giaever et al. (2004) Proc. Natl. Acad. Sci. USA 101:793; Eason et al. (2004) Proc. Natl. Acad. Sci. USA 101:11046; and Brenner (2004) Genome Biol. 5:240.

“Complementary” or “substantially complementary” refers to the hybridization or base pairing or the formation of a duplex between nucleotides or nucleic acids, such as, for instance, between the two strands of a double stranded DNA molecule or between an oligonucleotide primer and a primer binding site on a single stranded nucleic acid. Complementary nucleotides are, generally, A and T/U, or C and G. Two single-stranded RNA or DNA molecules are said to be substantially complementary when the nucleotides of one strand, optimally aligned and compared and with appropriate nucleotide insertions or deletions, pair with at least about 80% of the nucleotides of the other strand, usually at least about 90% to 95%, and more preferably from about 98 to 100%. Alternatively, substantial complementarity exists when an RNA or DNA strand will hybridize under selective hybridization conditions to its complement. Typically, selective hybridization will occur when there is at least about 65% complementary over a stretch of at least 14 to 25 nucleotides, at least about 75%, or at least about 90% complementary. See Kanehisa (1984) Nucl. Acids Res. 12:203. In certain embodiments, useful MIP guide sequences hybridize to sequences that flank the nucleotide base or series of bases to be queried.

Overall, five factors influence the efficiency and selectivity of hybridization of the primer to a second nucleic acid molecule. These factors, which are (i) primer length, (ii) the nucleotide sequence and/or composition, (iii) hybridization temperature, (iv) buffer chemistry and (v) the potential for steric hindrance in the region to which the primer is required to hybridize, are important considerations when non-random priming sequences are designed.

There is a positive correlation between primer length and both the efficiency and accuracy with which a primer will anneal to a target sequence; longer sequences have a higher Tₘ than do shorter ones, and are less likely to be repeated within a given target sequence, thereby cutting down on promiscuous hybridization. Primer sequences with a high G-C content or that comprise palindromic sequences tend to self-hybridize, as do their intended target sites, since unimolecular, rather than bimolecular, hybridization kinetics are generally favored in solution; at the same time, it is important to design a primer containing sufficient numbers of G-C nucleotide pairings to bind the target sequence tightly, since each such pair is bound by three hydrogen bonds, rather than the two that are found when A and T bases pair.

Hybridization temperature varies inversely with primer annealing efficiency, as does the concentration of organic solvents, e.g., formamide, that might be included in a hybridization mixture, while increases in salt concentration facilitate binding. Under stringent hybridization conditions, longer probes hybridize more efficiently than do shorter ones, which are sufficient under more permissive conditions. Stringent hybridization conditions typically include salt concentrations of less than about 1 M, less than about 500 mM, or less than about 200 mM. Hybridization temperatures range from as low as 0° C. to greater than 22° C., greater than about 30° C., and (most often) in excess of about 37° C. Longer fragments may require higher hybridization temperatures for specific hybridization. As several factors affect the stringency of hybridization, the combination of parameters is more important than the absolute measure of any one alone. Hybridization conditions are known to those skilled in the art and can be found in Current Protocols in Molecular Biology, John Wiley & Sons, N.Y. (1989), 6.3.1-6.3.6.

In certain embodiments, methods of amplifying MIPS are provided. Such methods include, but are not limited to, polymerase chain reaction (PCR), emulsion PCR (ePCR), bridge PCR, thermophilic helicase-dependent amplification (tHDA), linear polymerase reactions, strand displacement amplification (e.g., multiple displacement amplification), RCA (e.g., hyperbranched RCA, padlock probe RCA, linear RCA and the like), nucleic acid sequence-based amplification (NASBA) and the like, which are disclosed in the following references: Schweitzer et al. (2002) Nat. Biotech. 20:359; Demidov (2002) Expert Rev. Mol. Diagn. 2(6):89 (RCA); Mullis et al, U.S. Pat. Nos. 4,683,195; 4,965,188; 4,683,202; 4,800,159 (PCR); Gelfand et al., U.S. Pat. No. 5,210,015 (real-time PCR with “Taqman” probes); Wittwer et al., U.S. Pat. No. 6,174,670; Kacian et al., U.S. Pat. No. 5,399,491 (NASBA); Lizardi, U.S. Pat. No. 5,854,033; Aono et al., Japanese Patent Pub. JP 4-262799 (rolling circle amplification); Church, U.S. Pat. Nos. 6,432,360, 6,511,803 and U.S. Pat. No. 6,485,944 (replica amplification (e.g., polony amplification”); and the like.

Certain exemplary embodiments pertain to methods of amplifying MIPs by circularizing the MIP and performing rolling circle amplification (RCA). Several suitable RCA methods are known in the art. For example, linear RCA amplifies circular DNA by polymerase extension of a complementary primer. This process generates concatemerized copies of the circular DNA template such that multiple copies of a DNA sequence arranged end to end in tandem are generated. Exponential RCA is similar to the linear process except that it uses a second primer of identical sequence to the DNA circle (Lizardi et al. (1998) Nat. Genet. 19:225). This two-primer system achieves isothermal, exponential amplification. Exponential RCA has been applied to the amplification of non-circular DNA through the use of a linear probe that binds at both of its ends to contiguous regions of a target DNA followed by circularization using DNA ligase (i.e., padlock RCA) (Nilsson et al. (1994) Science 265(5181):2085). Hyperbranched RCA uses a second primer complementary to the rolling circle replication (RCR) product. This allows RCR products to be replicated by a strand-displacement mechanism, which can yield a billion-fold amplification in an isothermal reaction (Dahl et al. (2004) Proc. Natl. Acad. Sci. U.S.A. 101(13):4548).

Certain exemplary embodiments include the use of emulsion PCR (i.e., ePCR). As used herein, the term “ePCR” refers to PCR performed in a water-in-oil emulsion using a PCR mix that contains a limiting dilution of primer and nucleic acid template. The emulsion creates micro-compartments with, on average, a single primer and a single nucleic acid template each. If a nucleic acid template (e.g., a bead-bound oligonucleotide) and primer are present together in a single aqueous compartment, amplification of the template can occur. For a review of ePCR, see Dressman et al. (2003) Proc. Natl. Acad. Sci. USA 15:8817; and Shendure et al. (2005) Science 309:1728.

In certain exemplary embodiments, beads are provided for the immobilization of one or more of the oligonucleotides described herein. As used herein, the term “bead” refers to a discrete particle that may be spherical (e.g., microspheres) or have an irregular shape. Beads may be as small as approximately 0.1 μm in diameter or as large approximately several millimeters in diameter. Beads typically range in size from approximately 0.1 μm to 200 μm in diameter. Beads may comprise a variety of materials including, but not limited to, paramagnetic materials, ceramic, plastic, glass, polystyrene, methylstyrene, acrylic polymers, titanium, latex, sepharose, cellulose, nylon and the like.

In accordance with certain embodiments, beads may have functional groups on their surface which can be used to bind nucleic acid sequences to the bead. Nucleic acid sequences can be attached to a bead by hybridization (e.g., binding to a polymer), covalent attachment, magnetic attachment, affinity attachment and the like. For example, the bead can be coated with streptavidin and the nucleic acid sequence can include a biotin moiety. The biotin is capable of binding streptavidin on the bead, thus attaching the nucleic acid sequence to the bead. Beads coated with streptavidin, oligo-dT, and histidine tag binding substrate are commercially available (Dynal Biotech, Brown Deer, Wis.). Beads may also be functionalized using, for example, solid-phase chemistries known in the art, such as those for generating nucleic acid arrays, such as carboxyl, amino, and hydroxyl groups, or functionalized silicon compounds (see, for example, U.S. Pat. No. 5,919,523).

Methods of immobilizing oligonucleotides to a support are described are known in the art (beads: Dressman et al. (2003) Proc. Natl. Acad. Sci. USA 100:8817, Brenner et al. (2000) Nat. Biotech. 18:630, Albretsen et al. (1990) Anal. Biochem. 189:40, and Lang et al. Nucleic Acids Res. (1988) 16:10861; nitrocellulose: Ranki et al. (1983) Gene 21:77; cellulose: (Goldkorn (1986) Nucleic Acids Res. 14:9171; polystyrene: Ruth et al. (1987) Conference of Therapeutic and Diagnostic Applications of Synthetic Nucleic Acids, Cambridge U.K.; teflon-acrylamide: Duncan et al. (1988) Anal Biochem. 169:104; polypropylene: Polsky-Cynkin et al. (1985) Clin. Chem. 31:1438; nylon: Van Ness et al. (1991) Nucleic Acids Res. 19:3345; agarose: Polsky-Cynkin et al., Clin. Chem. (1985) 31:1438; and sephacryl: Langdale et al. (1985) Gene 36:201; latex: Wolf et al. (1987) Nucleic Acids Res. 15:2911).

As used herein, the term “attach” refers to both covalent interactions and noncovalent interactions. A covalent interaction is a chemical linkage between two atoms or radicals formed by the sharing of a pair of electrons (i.e., a single bond), two pairs of electrons (i.e., a double bond) or three pairs of electrons (i.e., a triple bond). Covalent interactions are also known in the art as electron pair interactions or electron pair bonds. Noncovalent interactions include, but are not limited to, van der Waals interactions, hydrogen bonds, weak chemical bonds (i.e., via short-range noncovalent forces), hydrophobic interactions, ionic bonds and the like. A review of noncovalent interactions can be found in Alberts et al., in Molecular Biology of the Cell, 3d edition, Garland Publishing, 1994.

In certain embodiments, beads described herein are arrayed on a solid support after amplification. The size of the array will depend on the composition and end use of the array. Generally, the array will comprise from two to as many as a billion or more beads, depending on the size of the beads and the substrate, as well as the end use of the array. Arrays range from high density to low density, having from about 10,000,000 to about 2,000,000,000 beads per cm² (high density) to about 100 to about 500 beads per cm² (low density). Beads can be covalently or noncovalently attached to the support. In certain aspects, the beads are spaced at a distance from one another sufficient to permit the identification of discrete features of the array. Bead based methods useful in the present invention are disclosed in PCT US05/04373.

The terms “substrate” and “solid support,” as used herein, refer to any material to which beads described herein can be attached and is amenable to at least one detection method. Possible substrates include, but are not limited to, glass and modified or functionalized glass, plastics (including acrylics, polystyrene and copolymers of styrene and other materials, polypropylene, polyethylene, polybutylene, polyurethanes, TEFLON®, and the like), polysaccharides, nylon or nitrocellulose, resins, silica or silica-based materials including silicon and modified silicon, carbon, metals, inorganic glasses, plastics, optical fiber bundles, and a variety of other polymers. In general, the substrates allow optical detection.

Solid supports of the invention may be fashioned into a variety of shapes. In certain embodiments, the solid support is substantially planar. Examples of solid supports include plates such as slides, microtitre plates, flow cells, coverslips, microchips, and the like, containers or vessels such as microfuge tubes, test tubes and the like, tubing, sheets, pads, films and the like. Additionally, the solid supports may be, for example, biological, nonbiological, organic, inorganic, or a combination thereof. In certain embodiments, beads and/or the solid supports may be functionalized such that the beads may be bound to the solid support. Functional groups are discussed further herein. In certain embodiments, the surface of the substrate is modified to contain wells, trenches, grooves, depressions or the like. Microspheres can be non-covalently associated in the wells, although the wells may additionally be chemically functionalized as is generally described below, cross-linking agents may be used, or a physical barrier may be used, i.e., a film or membrane over the beads.

In other embodiments, the surface of the substrate is modified to contain chemically modified sites, that can be used to associate, either covalently or non-covalently, the microspheres of the invention to the discrete sites or locations on the substrate. The term “chemically modified sites” in this context includes, but is not limited to, chemical functional groups including amino groups, carboxy groups, oxo groups, thiol groups, and the like; adhesives; of charged groups for the electrostatic association of the microspheres; chemical functional groups that renders the sites differentially hydrophobic or hydrophilic.

In certain embodiments, the beads of the invention are immobilized in a semi-solid medium. Semi-solid media comprise both organic and inorganic substances, and include, but are not limited to, polyacrylamide, cellulose and polyamide (nylon), as well as cross-linked agarose, dextran or polyethylene glycol. For example, beads described herein can be physically immobilized in a polymer gel. The gel can be larger in its X and Y dimensions (e.g., several centimeters) than its Z-dimension (e.g., approximately 30 microns), wherein the Z-dimension is substantially thicker than the beads that are immobilized within it (e.g., 30 micron gel versus one micron beads).

In still other aspects, a semi-solid medium of the invention is used in conjunction with a solid support. For example the gel described in the paragraph above can be polymerized in such a way that one surface of the gel is attached to a solid support (e.g., a glass surface), while the other surface of the gel is exposed. In certain aspects, the gel can be poured in such a way that the beads form a monolayer that resides near the exposed surface of the gel.

“Hybridization” refers to the process in which two single-stranded oligonucleotides bind non-covalently to form a stable double-stranded oligonucleotide. The term “hybridization” may also refer to triple-stranded hybridization. The resulting (usually) double-stranded oligonucleotide is a “hybrid” or “duplex.” “Hybridization conditions” will typically include salt concentrations of less than about 1 M, more usually less than about 500 mM and even more usually less than about 200 mM. Hybridization temperatures can be as low as 5° C., but are typically greater than 22° C., more typically greater than about 30° C., and often in excess of about 37° C. In certain exemplary embodiments, hybridization takes place at room temperature.

Hybridizations are usually performed under stringent conditions, i.e., conditions under which a probe will hybridize to its target subsequence. Stringent conditions are sequence-dependent and are different in different circumstances. Longer fragments may require higher hybridization temperatures for specific hybridization. As other factors may affect the stringency of hybridization, including base composition and length of the complementary strands, presence of organic solvents and extent of base mismatching, the combination of parameters is more important than the absolute measure of any one alone. Generally, stringent conditions are selected to be about 5° C. lower than the Tₘ for the specific sequence at s defined ionic strength and pH. Exemplary stringent conditions include salt concentration of at least 0.01 M to no more than 1 M Na ion concentration (or other salts) at a pH 7.0 to 8.3 and a temperature of at least 25° C. For example, conditions of 5×SSPE (750 mM NaCl, 50 mM Na phosphate, 5 mM EDTA, pH 7.4) and a temperature of 25-30° C. are suitable for allele-specific probe hybridizations. For stringent conditions, see for example, Sambrook, Fritsche and Maniatis, Molecular Cloning A Laboratory Manual, 2nd Ed. Cold Spring Harbor Press (1989) and Anderson Nucleic Acid Hybridization, 1^{st} Ed., BIOS Scientific Publishers Limited (1999).

In one aspect, hybridization-based assays include circularizing probes, such as padlock probes, rolling circle probes, molecular inversion probes, linear amplification molecules for multiplexed PCR, and the like, e.g. padlock probes being disclosed in U.S. Pat. Nos. 5,871,921; 6,235,472; 5,866,337; and Japanese patent JP. 4-262799; rolling circle probes being disclosed in Aono et al, JP-4-262799; Lizardi, U.S. Pat. Nos. 5,854,033; 6,183,960; 6,344,239; molecular inversion probes being disclosed in Hardenbol et al. (supra) and in Willis et al, U.S. Pat. No. 6,858,412; and linear amplification molecules being disclosed in Faham et al, U.S. patent publication 2003/0104459. Such probes are desirable because non-circularized probes can be digested with single stranded exonucleases thereby greatly reducing background noise due to spurious amplifications, and the like. In the case of molecular inversion probes (MIPs), padlock probes, and rolling circle probes, constructs for generating labeled target sequences are formed by circularizing a linear version of the probe in a template-driven reaction on a target oligonucleotide followed by digestion of non-circularized oligonucleotides in the reaction mixture, such as target oligonucleotides, unligated probe, probe concatemers, and the like, with an exonuclease, such as exonuclease I.

“Hybridization-based assay” means any assay that relies on the formation of a stable complex as the result of a specific binding event. In one aspect, a hybridization-based assay means any assay that relies on the formation of a stable duplex or triplex between a probe and a target nucleotide sequence for detecting or measuring such a sequence. In one aspect, probes of such assays anneal to (or form duplexes with) regions of target sequences in the range of from 8 to 100 nucleotides; or in other aspects, they anneal to target sequences in the range of from 8 to 40 nucleotides, or more usually, in the range of from 8 to 20 nucleotides. A “probe” in reference to a hybridization-based assay means an oligonucleotide that has a sequence that is capable of forming a stable hybrid (or triplex) with its complement in a target nucleic acid and that is capable of being detected, either directly or indirectly.

Hybridization-based assays include, without limitation, assays that use the specific base-pairing of one or more oligonucleotides as target recognition components, such as polymerase chain reactions, NASBA reactions, oligonucleotide ligation reactions, single-base extension reactions, circularizable probe reactions, allele-specific oligonucleotide hybridizations, either in solution phase or bound to solid phase supports, such as microarrays or microbeads, and the like. There is extensive guidance in the literature on hybridization-based assays, e.g., Hames et al., editors, Nucleic Acid Hybridization a Practical Approach (IRL Press, Oxford, 1985); Tijssen, Hybridization with Nucleic Acid Probes, Parts I & II (Elsevier Publishing Company, 1993); Hardiman, Microarray Methods and Applications (DNA Press, 2003); Schena, editor, DNA Microarrays a Practical Approach (IRL Press, Oxford, 1999); and the like.

“Amplifying” includes the production of copies of a nucleic acid molecule of the array or a nucleic acid molecule bound to a bead via repeated rounds of primed enzymatic synthesis. “In situ” amplification indicated that the amplification takes place with the template nucleic acid molecule positioned on a support or a bead, rather than in solution. In situ amplification methods are described in U.S. Pat. No. 6,432,360.

“Nucleoside” as used herein includes the natural nucleosides, including 2′-deoxy and 2′-hydroxyl forms, e.g. as described in Komberg and Baker, DNA Replication, 2nd Ed. (Freeman, San Francisco, 1992). “Analogs” in reference to nucleosides includes synthetic nucleosides having modified base moieties and/or modified sugar moieties, e.g., described by Scheit, Nucleotide Analogs (John Wiley, New York, 1980); Uhlman and Peyman, Chemical Reviews, 90:543-584 (1990), or the like, with the proviso that they are capable of specific hybridization. Such analogs include synthetic nucleosides designed to enhance binding properties, reduce complexity, increase specificity, and the like. Polynucleotides comprising analogs with enhanced hybridization or nuclease resistance properties are described in Uhlman and Peyman (cited above); Crooke et al, Exp. Opin. Ther. Patents, 6: 855-870 (1996); Mesmaeker et al, Current Opinion in Structural Biology, 5:343-355 (1995); and the like. Exemplary types of polynucleotides that are capable of enhancing duplex stability include oligonucleotide phosphoramidates (referred to herein as “amidates”), peptide nucleic acids (referred to herein as “PNAs”), oligo-2′-O-alkylribonucleotides, polynucleotides containing C-5 propynylpyrimidines, locked nucleic acids (LNAs), and like compounds. Such oligonucleotides are either available commercially or may be synthesized using methods described in the literature.

“Oligonucleotide” or “polynucleotide,” which are used synonymously, means a linear polymer of natural or modified nucleosidic monomers linked by phosphodiester bonds or analogs thereof. The term “oligonucleotide” usually refers to a shorter polymer, e.g., comprising from about 3 to about 100 monomers, and the term “polynucleotide” usually refers to longer polymers, e.g., comprising from about 100 monomers to many thousands of monomers, e.g., 10,000 monomers, or more. Oligonucleotides comprising probes or primers usually have lengths in the range of from 12 to 60 nucleotides, and more usually, from 18 to 40 nucleotides. Oligonucleotides and polynucleotides may be natural or synthetic. Oligonucleotides and polynucleotides include deoxyribonucleosides, ribonucleosides, and non-natural analogs thereof, such as anomeric forms thereof, peptide nucleic acids (PNAs), and the like, provided that they are capable of specifically binding to a target genome by way of a regular pattern of monomer-to-monomer interactions, such as Watson-Crick type of base pairing, base stacking, Hoogsteen or reverse Hoogsteen types of base pairing, or the like.

Usually nucleosidic monomers are linked by phosphodiester bonds. Whenever an oligonucleotide is represented by a sequence of letters, such as “ATGCCTG,” it will be understood that the nucleotides are in 5′ to 3′ order from left to right and that “A” denotes deoxyadenosine, “C” denotes deoxycytidine, “G” denotes deoxyguanosine, “T” denotes deoxythymidine, and “U” denotes the ribonucleoside, uridine, unless otherwise noted. Usually oligonucleotides comprise the four natural deoxynucleotides; however, they may also comprise ribonucleosides or non-natural nucleotide analogs. It is clear to those skilled in the art when oligonucleotides having natural or non-natural nucleotides may be employed in methods and processes described herein. For example, where processing by an enzyme is called for, usually oligonucleotides consisting solely of natural nucleotides are required. Likewise, where an enzyme has specific oligonucleotide or polynucleotide substrate requirements for activity, e.g., single stranded DNA, RNA/DNA duplex, or the like, then selection of appropriate composition for the oligonucleotide or polynucleotide substrates is well within the knowledge of one of ordinary skill, especially with guidance from treatises, such as Sambrook et al, Molecular Cloning, Second Edition (Cold Spring Harbor Laboratory, New York, 1989), and like references. Oligonucleotides and polynucleotides may be single stranded or double stranded.

The term “vessel,” as used herein, refers to any container suitable for holding on or more of the reactants (e.g., MIPs and/or immobilized nucleotide sequences) described herein. Examples of vessels include, but are not limited to, a microtitre plate, a test tube, a microfuge tube, a beaker, a flask, a multi-well plate, a cuvette, a flow system, a microfiber, a microscope slide and the like.

In certain embodiments, methods of determining the presence and/or location of one or more barcodes are provided. Determination the presence of a specific barcodes can be performed using variety of sequencing methods known in the art including, but not limited to, sequencing by hybridization (SBH), quantitative incremental fluorescent nucleotide addition sequencing (QIFNAS), stepwise ligation and cleavage, fluorescence resonance energy transfer (FRET), molecular beacons, TaqMan reporter probe digestion, pyrosequencing, fluorescent in situ sequencing (FISSEQ), allele-specific oligo ligation assays (e.g., oligo ligation assay (OLA), single template molecule OLA using a ligated linear probe and a rolling circle amplification (RCA) readout, ligated padlock probes, and/or single template molecule OLA using a ligated circular padlock probe and a rolling circle amplification (RCA) readout) and the like. A variety of light-based sequencing technologies are known in the art (Landegren et al. (1998) Genome Res. 8:769-76; Kwok (2000) Pharmocogenomics 1:95-100; and Shi (2001) Clin. Chem. 47:164-172).

In certain exemplary embodiments, sequential hybridization is used to determine the presence and/or location of one or more barcode sequences. For example, at each cycle of a sequencing reaction, oligonucleotide sequences complementary to four barcodes, each bearing one of four detectable markers or labels, is hybridized, and images are captured.

In certain exemplary embodiments, a detectable marker can feature a wide variety of physical or chemical properties including, but not limited to, light absorption, fluorescence, chemiluminescence, electrochemiluminescence, mass, charge, and the like. The signals based on such properties can be generated directly or indirectly. For example, a label can be a fluorescent molecule covalently attached to an oligonucleotide (e.g., attached to a molecular inversion probe) that directly generates an optical signal. Alternatively, a label can comprise multiple components, such as a hapten-antibody complex, that, in turn, may include fluorescent dyes that generated optical signals, enzymes that generate products that produce optical signals, or the like. In certain exemplary embodiments, the label is a fluorescent label that is directly or indirectly attached to an oligonucleotide sequence (e.g., attached to a molecular inversion probe). In one aspect, such fluorescent label is a fluorescent dye or quantum dot selected from a group consisting of from 2 to 6 spectrally resolvable fluorescent dyes or quantum dots.

Fluorescent labels and their attachment to oligonucleotides, such as oligonucleotide tags, are described in many reviews, including Haugland, Handbook of Fluorescent Probes and Research Chemicals, Ninth Edition (Molecular Probes, Inc., Eugene, 2002); Keller and Manak, DNA Probes, 2nd Edition (Stockton Press, New York, 1993); Eckstein, editor, Oligonucleotides and Analogues: A Practical Approach (IRL Press, Oxford, 1991); Wetmur, Critical Reviews in Biochemistry and Molecular Biology, 26:227-259 (1991); and the like. Particular methodologies applicable to the invention are disclosed in the following sample of references: Fung et al., U.S. Pat. No. 4,757,141; Hobbs, Jr., et al. U.S. Pat. No. 5,151,507; Cruickshank, U.S. Pat. No. 5,091,519. In one aspect, one or more fluorescent dyes are used as labels for labeled target sequences, e.g., as disclosed by Menchen et al., U.S. Pat. No. 5,188,934 (4,7-dichlorofluorscein dyes); Begot et al., U.S. Pat. No. 5,366,860 (spectrally resolvable rhodamine dyes); Lee et al., U.S. Pat. No. 5,847,162 (4,7-dichlororhodamine dyes); Khanna et al., U.S. Pat. No. 4,318,846 (ether-substituted fluorescein dyes); Lee et al., U.S. Pat. No. 5,800,996 (energy transfer dyes); Lee et al., U.S. Pat. No. 5,066,580 (xanthine dyes): Mathies et al., U.S. Pat. No. 5,688,648 (energy transfer dyes); and the like. Labelling can also be carried out with quantum dots, as disclosed in the following patents and patent publications: U.S. Pat. Nos. 6,322,901; 6,576,291; 6,423,551; 6,251,303; 6,319,426; 6,426,513; 6,444,143; 5,990,479; 6,207,392; 2002/0045045; 2003/0017264; and the like. As used herein, the term “fluorescent label” includes a signaling moiety that conveys information through the fluorescent absorption and/or emission properties of one or more molecules. Such fluorescent properties include fluorescence intensity, fluorescence life time, emission spectrum characteristics, energy transfer, and the like.

Commercially available fluorescent nucleotide analogues readily incorporated into the labeling oligonucleotides include, for example, Cy3-dCTP, Cy3-dUTP, Cy5-dCTP, Cy5-dUTP (Amersham Biosciences, Piscataway, N.J.), fluorescein-12-dUTP, tetramethylrhodamine-6-dUTP, TEXAS RED™-5-dUTP, CASCADE BLUE™-7-dUTP, BODIPY® TMFL-14-dUTP, BODIPY® TMR-14-dUTP, BODIPY® TMTR-14-dUTP, RHODAMINE GREEN™-5-dUTP, OREGON GREENR™ 488-5-dUTP, TEXAS RED™-12-dUTP, BODIPY® TM 630/650-14-dUTP, BODIPY® TM 650/665-14-dUTP, ALEXA FLUOR™ 488-5-dUTP, ALEXA FLUOR™ 532-5-dUTP, ALEXA FLUOR™ 568-5-dUTP, ALEXA FLUOR™ 594-5-dUTP, ALEXA FLUOR™ 546-14-dUTP, fluorescein-12-UTP, tetramethylrhodamine-6-UTP, TEXAS RED™-5-UTP, mCherry, CASCADE BLUE™-7-UTP, BODIPY® TM FL-14-UTP, BODIPY® TMR-14-UTP, BODIPY® TM TR-14-UTP, RHODAMINE GREEN™-5-UTP, ALEXA FLUOR™ 488-5-UTP, LEXA FLUOR™ 546-14-UTP (Molecular Probes, Inc. Eugene, Oreg.). Protocols are available for custom synthesis of nucleotides having other fluorophores. Henegariu et al., “Custom Fluorescent-Nucleotide Synthesis as an Alternative Method for Nucleic Acid Labeling,” Nature Biotechnol. 18:345-348 (2000).

Other fluorophores available for post-synthetic attachment include, inter alia, ALEXA FLUOR™ 350, ALEXA FLUOR™ 532, ALEXA FLUOR™ 546, ALEXA FLUOR™ 568, ALEXA FLUOR™ 594, ALEXA FLUOR™ 647, BODIPY® 493/503, BODIPY® FL, BODIPY® R6G, BODIPY® 530/550, BODIPY® TMR, BODIPY® 558/568, BODIPY® 558/568, BODIPY® 564/570, BODIPY® 576/589, BODIPY® 581/591, BODIPY® 630/650, BODIPY® 650/665, Cascade Blue, Cascade Yellow, Dansyl, lissamine rhodamine B, Marina Blue, Oregon Green 488, Oregon Green 514, Pacific Blue, rhodamine 6G, rhodamine green, rhodamine red, tetramethyl rhodamine, Texas Red (available from Molecular Probes, Inc., Eugene, Oreg.), and Cy2, Cy3.5, Cy5.5, and Cy7 (Amersham Biosciences, Piscataway, N.J. USA, and others).

FRET tandem fluorophores may also be used, such as PerCP-Cy5.5, PE-Cy5, PE-Cy5.5, PE-Cy7, PE-Texas Red, and APC-Cy7; also, PE-Alexa dyes (610, 647, 680) and APC-Alexa dyes.

Metallic silver particles may be coated onto the surface of the array to enhance signal from fluorescently labeled oligos bound to the array. Lakowicz et al. (2003) BioTechniques 34:62.

Biotin, or a derivative thereof, may also be used as a label on a detection oligonucleotide, and subsequently bound by a detectably labeled avidin/streptavidin derivative (e.g. phycoerythrin-conjugated streptavidin), or a detectably labeled anti-biotin antibody. Digoxigenin may be incorporated as a label and subsequently bound by a detectably labeled anti-digoxigenin antibody (e.g. fluoresceinated anti-digoxigenin). An aminoallyl-dUTP residue may be incorporated into a detection oligonucleotide and subsequently coupled to an N-hydroxy succinimide (NHS) derivatized fluorescent dye, such as those listed supra. In general, any member of a conjugate pair may be incorporated into a detection oligonucleotide provided that a detectably labeled conjugate partner can be bound to permit detection. As used herein, the term antibody refers to an antibody molecule of any class, or any sub-fragment thereof, such as an Fab.

Other suitable labels for detection oligonucleotides may include fluorescein (FAM), digoxigenin, dinitrophenol (DNP), dansyl, biotin, bromodeoxyuridine (BrdU), hexahistidine (6×His), phosphor-amino acids (e.g. P-tyr, P-ser, P-thr), or any other suitable label. In one embodiment the following hapten/antibody pairs are used for detection, in which each of the antibodies is derivatized with a detectable label: biotin/α-biotin, digoxigenin/a-digoxigenin, dinitrophenol (DNP)/α-DNP, 5-Carboxyfluorescein (FAM)/α-FAM.

Oligonucleotide sequences can be indirectly labeled, especially with a hapten that is then bound by a capture agent, e.g., as disclosed in Holtke et al., U.S. Pat. Nos. 5,344,757; 5,702,888; and 5,354,657; Huber et al., U.S. Pat. No. 5,198,537; Miyoshi, U.S. Pat. No. 4,849,336; Misiura and Gait, PCT publication WO 91/17160; and the like. Many different hapten-capture agent pairs are available for use with the invention, either with a target sequence or with a detection oligonucleotide used with a target sequence, as described below. Exemplary, haptens include, biotin, des-biotin and other derivatives, dinitrophenol, dansyl, fluorescein, CY5, and other dyes, digoxigenin, and the like. For biotin, a capture agent may be avidin, streptavidin, or antibodies. Antibodies may be used as capture agents for the other haptens (many dye-antibody pairs being commercially available, e.g., Molecular Probes, Eugene, Oreg.).

It is to be understood that the embodiments of the present invention which have been described are merely illustrative of some of the applications of the principles of the present invention. Numerous modifications may be made by those skilled in the art based upon the teachings presented herein without departing from the true spirit and scope of the invention. The contents of all references, patents and published patent applications cited throughout this application are hereby incorporated by reference in their entirety for all purposes.

The following examples are set forth as being representative of the present invention. These examples are not to be construed as limiting the scope of the invention as these and other equivalent embodiments will be apparent in view of the present disclosure, figures, and accompanying claims.

### EXAMPLE 1

### Array Beads for Sequencing Single Tags

The biochemistry described in this example enzymatically attaches tags to each bead, via N species (N=number of base pairs queried, usually 12) of barcode circles. Each barcode circle has three main parts: 1) a degenerate ‘query’ portion which base pairs with the unknown region of the template; 2) a fixed portion which directs the degenerate ‘query’ portion to the unknown region by base pairing with fixed sequence on each side of the unknown tag, and 3) barcode which correlates with the identity of one base in the degenerate ‘query’ portion and is interrogated by hybridization once on the instrument. Each barcode specifies a tag position and the base identity at that position. To determine 12 base pairs of sequence in a population of beads will require 4*12=48 ‘query ligation barcodes’. The barcode circles will potentially be structured in different ways. For example, all positioning bases could be at the 5′ and, and degenerate bases at the 3′ end, or vice versa. Alternatively, degenerate bases could be present at both the 5′ and 3′ ends, with several positioning bases just internal to them.

Since the total number of barcode sequences is low, they will be designed for zero cross-hybridization by keeping the Tₘ of closest neighbor duplexes well below room temperature. The goal should will be specific hybridization at room temperature in order to eliminate temperature control from the instrument. The Tₘ differential between barcodes will be as close to zero as possible for uniform hybridization efficiency at a given temperature.

The description that follows is one potential implementation of this scheme.

### Step 1

Clonal beads are generated by emulsion PCR (ePCR) to serve as sequencing templates, as described in the art. In the example here, the templates contain a single tag of unknown sequence of 12 base pairs in length. The templates can be single-stranded by NaOH treatment, as described in the art.

### Step 2

The next several steps take place with the beads present as a mixture in a tube (not yet poured to form an array). A series of molecular inversion probes (MIPs) will be hybridized to the template-bearing beads. The MIPs will be approximately 100 nucleotides in length. Each MIP will contain several (e.g., six) degenerate bases at both its 5′ and 3′ ends. Just internal to these degenerate bases will be several bases whose purpose is to guide the MIP towards hybridizing at a specific position on the bead-bound template targets. Specifically, they will be targeted to bind such that the 12 degenerate bases overlap with the 12 unknown bases that are targeted for sequencing. The remainder of the MIP will contain one or several ‘barcode’ sequences. The population of MIPs will be structured such that there are 48 possible barcodes, and the barcode on any given MIP is correlated with the identity of one base at one of the 12 degenerate positions. Thus 12×4=48 possible MIPs to be mixed together, each bearing one of 48 barcodes.

### Step 3

Taq ligase will be added and incubated at 55° C. for an extended period. In one embodiment, a lower temperature will be used, possibly with T4 ligase, depending on what balance of sensitivity and specificity is necessary. The MIPs should selectively seal when there is appropriate matching at the degenerate positions.

### Step 4

Exonuclease I will be added. Unextended primers on beads will be degraded, as will extended primers on beads. However, if a MIP with a sealed ligation junction is present and hybridized to a given extended template, the Exo I will stop when a flush end is achieved. The Exo I will be removed by multiple washings of the beads.

### Step 5

Phi29 or Bst polymerase will be added for linear rolling circle amplification. This will result in both the barcode being transferred to the strand that is covalently attached to the bead, as well as in boosting signal in terms of the number of barcodes on each bead.

### Step 6

Beads will be arrayed and sequencing will be performed by sequential hybridization, imaging, and stripping. At each cycle, sequences complementary to four barcodes, each bearing one of four fluorescent labels, will be hybridized and images will be captured. Without intending to be bound by theory, each bead is expected to light up one of four colors at each cycle. After hybridization and imaging, the probes will be chemically stripped and the process repeated to interrogate barcodes that inform us about a different base position.

### Example II

### Array Beads for Sequencing Multiple Tags

One limitation to the method described in Example I is the need to perform rolling circle amplification once the barcode circle has ligated to covalently attach the barcode sequence to the bead-bound strand. This is accomplished by nuclease digestion, e.g., Exonuclease I digestion, which will digest the bead-bound strand 3′ to 5′ until the strand is flush with the hybridized circle. This 3′ end is then extended in a polymerization reaction with a strand-displacing polymerase such as phi 29 or Bst. In the case of a bead which has amplified a paired-tag library molecule, the exonuclease strategy will allow rolling circle amplification of the 3′-most tag, but not the inner 5′ tag. The following protocol, which should be performed before ligation of query barcodes, allows subsequent rolling circle amplification to be performed on both circle-bound tags simultaneously.

In this example, common primer sequence is denoted by “---” and is sequence-independent except where noted. Unique tags of unknown sequence are depicted as “NNN”. Segment lengths are not to scale.

The goal is to convert a bead with 1 population of strands:

BEAD5′---------NNNNNNNNNNNN----------NNNNNNNNNNNN----------T---A---A3′

into a bead with 2 populations of strands (approximately equal number of each):

1) 5′---------NNNNNNNNNNNN------------NNNNNNNNNNNN----------T---3′
2) 5′---------NNNNNNNNNNNN------------3′

First, an equimolar mixture of two extension oligonucleotides containing periodic deoxyuridines (in place of thymidine) will be hybridized. One extension oligonucleotide will be a perfect match for the template, and one will contain a single mismatched nucleotide at the 3′ terminus:

```
        3′A---U---U5′
        3′T---U---U5′
BEAD5′---------NNNNNNNNNNNN----------NNNNNNNNNNNN----------T---A---A3′
                                                                                                                  3′A---U---U5′
and
BEAD5′---------NNNNNNNNNNNN----------NNNNNNNNNNNN----------T---A---A3′
                                                                                                                  3′T---U---U5′
```

Then, polymerase extension will be performed with dNTPs. Perfectly-matched primers will be extended, and those with a one base pair mismatch will not be extended. Approximately equal numbers of each strand will be present on each bead:

```
BEAD5′---------NNNNNNNNNNNN----------NNNNNNNNNNNN----------T---A---A3′
        3′---------NNNNNNNNNNNN----------NNNNNNNNNNNN----------A---U---U5′
and
BEAD5′---------NNNNNNNNNNNN----------NNNNNNNNNNNN----------T---A---A3′
                                                                                                                  3′T---U---U5′
```

Then, digestion with USER™ enzyme (New England Biolabs, Beverly, Mass.), which excises deoxyuridines, will be performed. Extension oligonucleotides extended by polymerase will be shortened. Extension oligonucleotides not extended will be removed completely:

BEAD5′---------NNNNNNNNNNNN----------NNNNNNNNNNNN----------T---A---A3′
3′---------NNNNNNNNNNNN----------NNNNNNNNNNNN----------A---5′
and
BEAD5′---------NNNNNNNNNNNN----------NNNNNNNNNNNN----------T---A---A3′

Protection oligonucleotides will be hybridized, which will base pair with the central common priming sequence of the templates which were not double-stranded by polymerase extension:

```
BEAD5′---------NNNNNNNNNNNN----------NNNNNNNNNNNN----------T---A---A3′
        3′---------NNNNNNNNNNNN----------NNNNNNNNNNNN----------A---5′
and
BEAD5′---------NNNNNNNNNNNN----------NNNNNNNNNNNN----------T---A---A3′
                                                  3′----------5′
```

Then, exonucleolysis will be performed with Exonuclease I, a 3′ to 5′ single strand-specific exonuclease. Two populations of bead-bound strands will be generated:

```
BEAD5′---------NNNNNNNNNNNN----------NNNNNNNNNNNN----------T---3′
        3′---------NNNNNNNNNNNN----------NNNNNNNNNNNN----------A---3′
and
BEAD5′---------NNNNNNNNNNNN----------3′
                                                  3′----------5′
```

Each bead will now be bound by approximately equal amounts of two species. One will support rolling circle amplification of the 3′-most query circle, and the other will support rolling circle amplification of the 5′-most query circle.

### Example III

### Array Beads for Sequencing Paired Tag Library

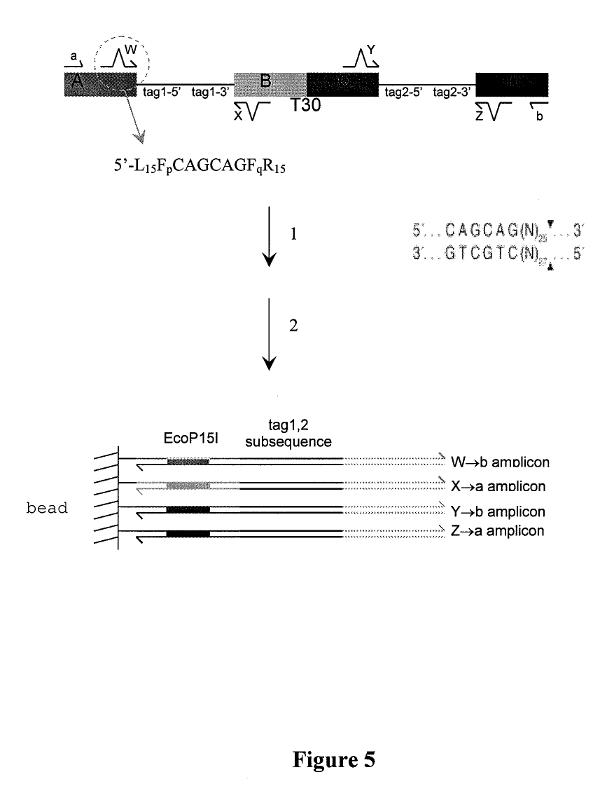

A paired tag library will be generated. FIG. 5 depicts a paired tag library and shows oligonucleotide binding sites. Via EcoP15I digestion of W-primed amplicons, positions +1 to +10 of the tag1-5′ can be queried. Similarly, +1 to +10 of tag1-3′, of tag2-5′, and of tag2-3′ can be queried by X-, Y-, and Z-primed amplicons, respectively. 1st round ePCR with single-molecule template, free primer b, and beads loaded with biotin-labeled versions of W, Y, X and Z will be performed (FIG. 5, Step 1). Bead-bound double-stranded amplicons W-b and Y-b will be generated. The emulsion will be broken and 2nd round e-PCR will be performed with 1st rounds beads, no exogenous template and free primer a (FIG. 5, Step 2). Bead-bound double-stranded amplicons X-a and Z-a will be generated, and the W-b and Y-b amplicons will be primer extended to assure that they are double-stranded.

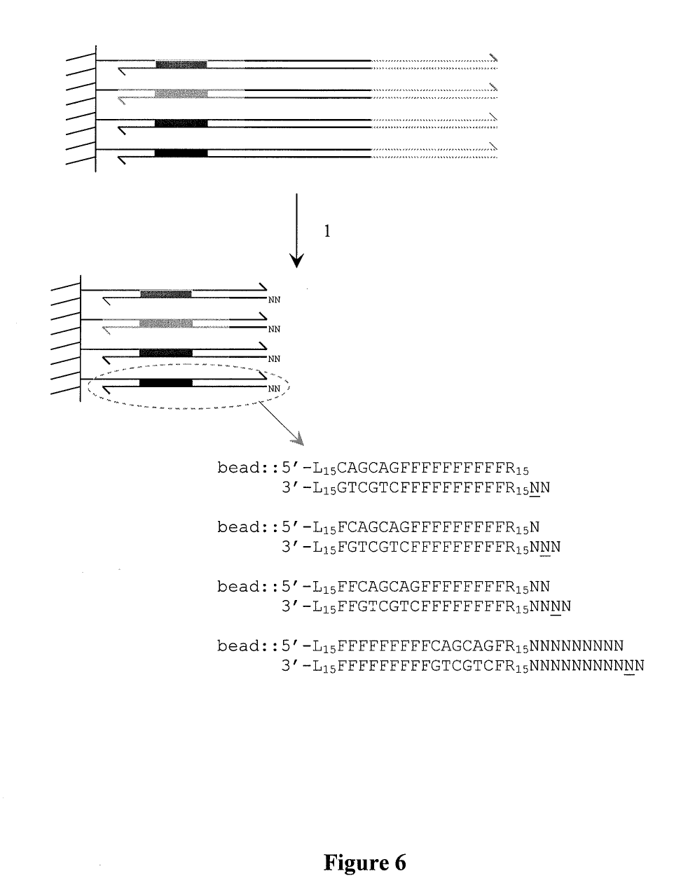

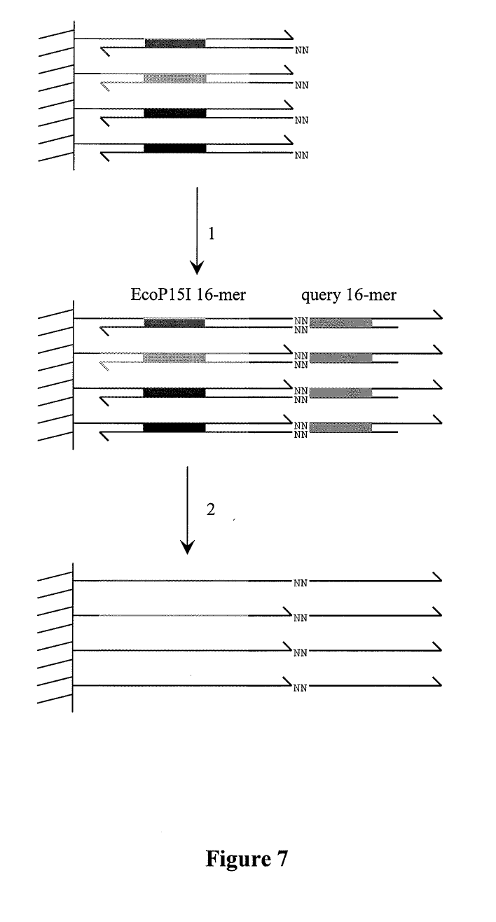

40 types of primed-amplicons, each with a different EcoP51I 16-mer that specifies: (1) the constant sequences A-D; and (2) the query position of the associated tag subsequence will be generated (FIG. 6). EcoP51I digestion will be performed in the presence of sinefungin (See Biochemical and Biophysical Research Communications (2005) 334:803) (FIG. 6, Step 1). Each position to be queried (underlined) will be associated with a specific EcoP15I 16-mer. 40 types of digested amplicons, each with a different EcoP15I 16-mer and a two nucleotide 5′ overhang are then ready to be sequence-queried by hybridization-ligation (FIG. 7).

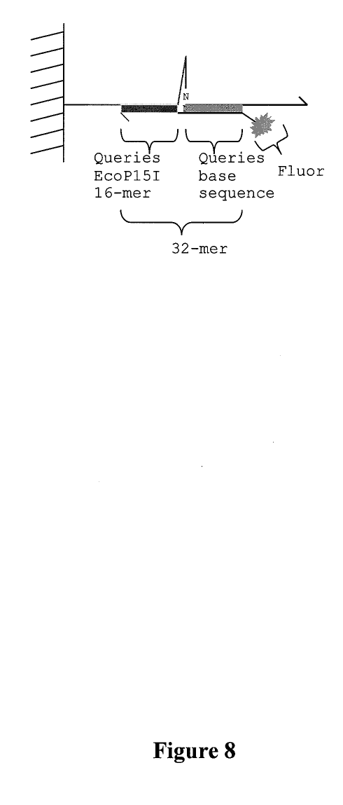

16 query adaptors will be ligated with all possible two nucleotide 3′ overhangs, with 4 different 16-mer sequences associable with the identity of the 5′-most query base (magenta) (FIG. 7, Step 1). 160 different possible pairings of 40 EcoP15I and 4 query 16-mers, separated by 17-26 base pairs, should be present on every bead. Non-biotinylated strands will be denatured and washed away. The remaining strands will be immobilized and loaded into a flow cell (FIG. 7, Step 2). No further enzymology is necessary after this point. 40 four-color hybridization-imaging cycles will be performed to read four contiguous 10-mer tag sequences. At each cycle, the probe will be a population of 32-mers with a constant 3′ 16-mer sequence complementary to one of the 40 EcoP15I 16-mers being interrogated, with four differentially fluor-labeled 5′ 16-mer sequences complementary to each of the four base-query 16-mers. An example hybridization is schematized in FIG. 8.

What is claimed is:

1. A method of analyzing an array of nucleic acid sequences comprising the steps of:
a) providing a plurality of immobilized query oligonucleotide sequences;
b) providing a plurality of molecular inversion probes, each molecular inversion probe having a tag sequence, a barcode sequence, and two guide sequences;
c) hybridizing the molecular inversion probes to the immobilized query oligonucleotide sequences;
d) performing rolling circle amplification such that the barcode sequence of one molecular inversion probe is transferred to one immobilized query oligonucleotide sequence;
e) arraying the immobilized query oligonucleotide sequences; and
f) identifying barcodes present on an immobilized query oligonucleotide sequence.

2. The method of claim 1, wherein multiple barcodes are present on the immobilized query oligonucleotide sequence.

3. The method of claim 1, wherein one or more steps prior to arraying can be performed at room temperature.

4. The method of claim 1, wherein the step of identifying barcodes present is performed by sequencing by hybridization.

5. The method of claim 1, wherein the plurality of immobilized query oligonucleotide sequences are generated by emulsion PCR.

6. The method of claim 1, wherein the plurality of immobilized query oligonucleotide sequences are immobilized on beads.

7. The method of claim 6, wherein the beads are arranged on a solid support.

8. The method of claim 4, wherein sequencing by hybridization includes an oligonucleotide comprising a detectable label.

9. The method of claim 8, wherein the detectable label is a fluorescent label.

10. The method of claim 1, wherein the plurality of immobilized query oligonucleotide sequences is a paired tag library.

11. A method of providing a bead having two populations of immobilized query oligonucleotide sequences comprising the steps of:
a) providing a plurality of query oligonucleotide sequences immobilized on a bead;
b) providing a plurality of first oligonucleotide sequences and second oligonucleotide sequences, wherein the first oligonucleotide sequences are complementary to query oligonucleotide sequences, and wherein the second oligonucleotide sequences comprise a mismatch at their 3′ termini when compared to the query oligonucleotide sequences;
c) hybridizing the first and second oligonucleotide sequences to the query oligonucleotide sequences;
d) adding polymerase to extend the hybridized oligonucleotide sequences;
e) adding an enzyme that cleaves a specific deoxynucleoside;
f) hybridizing a protection oligonucleotide to single stranded query oligonucleotide sequences; and
g) adding a single strand-specific exonuclease to generate a bead having two populations of immobilized query oligonucleotide sequences.

12. The method of claim 11, wherein the enzyme that cleaves a specific deoxynucleoside cleaves deoxyuridine.

13. The method of claim 11, wherein the first and second oligonucleotide sequences contain one or more deoxyuridines at their 5′ termini.

14. The method of claim 11, wherein the single strand-specific exonuclease is Exonuclease I.

15. The method of claim 11, wherein a plurality of beads are arranged on a solid support.

16. A method of analyzing an array of nucleic acid sequences comprising the steps of:
a) providing a plurality of query oligonucleotide sequences immobilized on beads;
b) hybridizing a plurality of first oligonucleotide sequences and second oligonucleotide sequences to the immobilized oligonucleotide sequences, wherein the first oligonucleotide sequences are complementary to query oligonucleotide sequences, and wherein the second oligonucleotide sequences comprise a mismatch at their 3′ termini when compared to the query oligonucleotide sequences;
c) adding polymerase to extend the hybridized oligonucleotide sequences;
d) adding an enzyme that cleaves a specific deoxynucleoside;
e) hybridizing a protection oligonucleotide to single stranded query oligonucleotide sequences;
f) adding a single strand-specific exonuclease to generate two populations of immobilized query oligonucleotide sequences;
g) hybridizing a plurality of molecular inversion probes to the immobilized query oligonucleotide sequences;
g) performing rolling circle amplification such that a barcode sequence of a molecular inversion probe is transferred to an immobilized query oligonucleotide sequence;
i) arraying the immobilized query oligonucleotide sequences; and
j) identifying barcodes present on an immobilized query oligonucleotide sequence.

17. The method of claim 16, wherein one or more steps prior to arraying can be performed at room temperature.

18. The method of claim 16, wherein the step of identifying barcodes present is performed by sequencing by hybridization.

19. The method of claim 18, wherein sequencing by hybridization includes an oligonucleotide comprising a detectable label.

20. The method of claim 16, wherein the beads are arranged on a solid support.
